(19) United States
(12) Patent Application Publication
(10) Pub. No.: US 2012/0265489 A1
(43) Pub. Date: Oct. 18, 2012

(54) Compliance Tracking and Intelligent Suggesting with Information Assemblages

(75) Inventors: Anastasio Vincent DeAscentis, Boardman, OH (US); Jason Robert Cuddy, Boardman, OH (US); Stephanie Ip Hunter, Canfield, OH (US); Scott James Andrews, Chagrin Falls, OH (US); April Dawn Bixel, Canfield, OH (US); Brian Theodore Tackett, Canfield, OH (US)

(73) Assignee: VIA680 LLC, Youngstown, OH (US)

(21) Appl. No.: 13/086,150

(22) Filed: Apr. 13, 2011

(51) Int. Cl. G06F 15/00

(52) U.S. Cl. 702/182

(57) ABSTRACT

An information assemblage that includes a plurality of assets can be created and disseminated to a target audience. For instance, a target device can access the information assemblage via a secure web-based portal. Feedback corresponding to consumption of the information assemblage can be received. Based upon the feedback, a compliance measurement can be generated. Additionally or alternatively, suggestions can be yielded as a function of the feedback. For example, the suggestions can relate to forming an information assemblage, determining how to evaluate compliance from feedback based on the information assemblage, or supplying supplemental asset(s) to a target device.

### BACKGROUND

Computing devices are ubiquitous in society, and the interconnected nature of computing devices has facilitated vast exchange of information. Information is generally able to be transferred between individuals employing computing devices in a variety of manners. For example, information can made available on a website, sent as a message (e.g., email, instant message, etc.), or the like.

Depending on the manner by which information is exchanged, an information source that provides information conventionally may or may not be able to obtain feedback from the recipient. For instance, common approaches may allow for the information source to glean whether a recipient obtains the information supplied by the information source. Pursuant to an illustration, the information source can post information on a server or a website. The information source can supply credentials to a recipient and instruct the recipient to obtain and view the posted information. For instance, feedback related to whether the recipient obtained the posted information may conventionally be supplied to the information source.

By way of another illustration, an information source can generate an email that includes the information and send the email to the one or more recipients. When the email is sent to the one or more recipients, feedback provided to the information source is typically limited. The feedback can include a reply email sent in response. Additionally or alternatively, email tracking can be employed to monitor the delivery of the email to the one or more recipients; such email tracking, for instance, can reveal a time and date that the email was received or opened, an Internet Protocol (IP) address of a recipient, and so forth.

Moreover, information can be supplied by the information source to one or more recipients for various purposes. The information can be supplied, for instance, to teach or train the one or more recipients. Accordingly, an information source oftentimes is unable to detect whether information supplied thereby has been consumed or understood by the one or more recipients.

### SUMMARY

In accordance with one or more embodiments and corresponding disclosure thereof, various aspects are described related to creating and disseminating an information assemblage that includes a plurality of assets to a target audience. For instance, a target device can access the information assemblage via a secure web-based portal. Feedback corresponding to consumption of the information assemblage can be received. Based upon the feedback, a compliance measurement can be generated. Additionally or alternatively, suggestions can be yielded as a function of the feedback. For example, the suggestions can relate to forming an information assemblage, determining how to evaluate compliance from feedback based on the information assemblage, or supplying supplemental asset(s) to a target device.

According to related aspects, a method of measuring configured for execution on a processor of a message system is described herein. The method can include maintaining an information assemblage that includes a plurality of assets in memory of the message system. Moreover, the method can include assigning respective weights to assets in a selected subset of the plurality of assets from the information assemblage. Still yet, the method can include disseminating the information assemblage. The method can also include monitoring feedback related to the information assemblage. Moreover, the method can include evaluating metrics for the assets in the selected subset from the feedback. Further, the method can include generating a measure of compliance by combining results of the metrics for the assets in the selected subset as a function of the respective weights.

Another aspect relates to a method of forming a new information assemblage configured for execution on a processor of a message system. The method can include initiating creation of the new information assemblage. Moreover, the method can include adding a plurality of assets to the new information assemblage in accordance with a suggestion generated based upon weighted ratings, wherein the plurality of assets of the new information assemblage comprises one or more asset types, the one or more asset types comprise one or more of video information, image information, audio information, documents, or assessments. Further, the method can include distributing the new information assemblage.

Yet another aspect relates to a method of supplying a supplemental asset configured for execution on a processor of a message system. The method can include distributing an information assemblage to a user device, wherein the information assemblage comprises a plurality of assets of one or more asset types, the one or more asset types comprise one or more of video information, image information, audio information, documents, or assessments. Further, the method can include receiving feedback from the user device related to the information assemblage. Moreover, the method can include selecting the supplemental asset from a library based upon the feedback from the user device and respective weighted ratings associated with a set of assets in the library. The method can also include distributing the supplemental asset to the user device.

Still another aspect relates to a system that distributes information assemblages. The system can include memory that retains feedback history and a library that includes a set of assets. Moreover, the system can include a rating component that generates weighted ratings corresponding to characteristics of the assets in the set based at least in part upon the feedback history retained in the memory. Further, the system can include an assembly component that forms an information assemblage with a subset of assets from the set retained in the library based at least in part upon suggestions yielded from the weighted ratings corresponding to the characteristics of the assets in the set. The system can also include a distribution component that disseminates the information assemblage to a target audience.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

The claimed subject matter may take physical form in certain parts and arrangement of parts, embodiments of which will be described in detail in this specification and illustrated in the accompanying drawings which form a part hereof and wherein:

FIG. 1 illustrates an example system that creates and distributes an information assemblage;

FIGS. 2-3 illustrate example graphical user interfaces that can be provided by a message system to a target device via a secure web-based portal;

FIG. 4 illustrates an example system that measures compliance using an information assemblage;

FIG. 5 illustrates an example system that forms an information assemblage for dissemination to a target audience;

FIG. 6 illustrates an example system that generates weighted ratings according to various aspects described herein;

FIG. 7 illustrates an example system that supplies supplemental asset(s) in addition to assets included in an information assemblage;

FIG. 8 illustrates a methodology that facilitates generating an information assemblage;

FIG. 9 illustrates a methodology that facilitates creating a custom rating system for assets of an information assemblage;

FIG. 10 illustrates a methodology of measuring compliance;

FIG. 11 illustrates a methodology of forming a new information assemblage;

FIG. 12 illustrates a methodology of supplying a supplemental asset; and

FIG. 13 illustrates an example computing device that can be used in accordance with the systems and methodologies disclosed herein.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

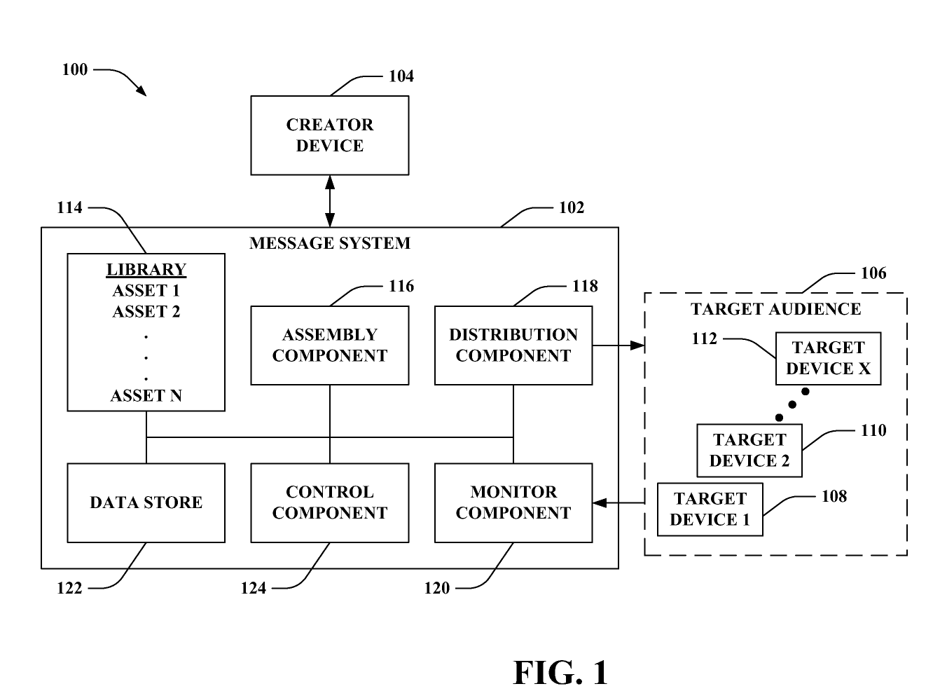

Referring now to the drawings, FIG. 1 illustrates a system 100 that creates and distributes an information assemblage. The system 100 includes a message system 102 that receives input from a creator device 104. Based upon the received input, the message system 102 can yield an information assemblage, which can be distributed to a target audience 106. The target audience 106 can include one or more target devices. As depicted, the target audience 106 can include a target device 1 108, a target device 2 110, . . . , and a target device X 112, where X can be substantially any integer. However, it is to be appreciated that the claimed subject matter is not so limited.

An information assemblage includes information that is assembled and disseminated to the target audience 106. The message system 102 includes a library 114, an assembly component 116, and a distribution component 118. The library 114 includes a set of assets (e.g., asset 1, asset 2, . . . , asset N, where N can be substantially any integer). The assembly component 116 can create an information assemblage that includes a plurality of the assets from the library 114. The created information assemblage can be maintained in a data store 122 of the message system 102, for instance. Moreover, the distribution component 118 can disseminate the created information assemblage to the target devices 108-112 in the target audience 106.

The creator device 104 can access the message system 102 via a secure web-based portal. Through the secure web-based portal, the creator device 104 can upload an asset to the library 114 of the message system 102. Moreover, through the secure web-based portal, the creator device 104 can supply an input to the assembly component 116 to create an information assemblage. The creator device 104 can further provide an input to the distribution component 118 through the secure web-based portal to disseminate the created information assemblage to the target devices 108-112 in the target audience 106.

Moreover, the target devices 108-112 can access the message system 102 via a secure web-based portal. When an information assemblage is disseminated, transmitted, transferred, distributed, forwarded, sent, etc. to a particular target device by the distribution component 118, the information assemblage is made accessible to the particular target device through the secure web-based portal. Accordingly, since the information assemblage is accessible, the particular target device can consume the information assemblage through the secure web-based portal.

The library 114 can include assets supplied by the creator device 104. For example, when a user associated with the creator device 104 initializes an account with the message system 102, the library 114 for the user can be created. Moreover, one or more assets can be uploaded from the creator device 104 to the library 114 included in the message system 102. According to another example, an asset can be created by the creator device 104 in the message system 102. Following this example, the creator device 104 can supply content to the message system 102, where the content is used to generate an assessment in the message system 102, for instance. It is also contemplated that one or more assets can be added to the library 114 in substantially any other manner; for example, assets can be automatically included in the library 114 (e.g., upon account initialization, added to libraries of a plurality of users, etc.), included in the library 114 as a function of a selection received from the creator device 104 or an administrator, or the like. Moreover, assets of information assemblage(s) previously created by the creator device 104 can also be retained in the library 114. Further, one or more assets in the library 114 can be from a public pool of assets.

The library 114 can include assets of various asset types. For example, an asset type can be video information, image information, audio information, documents, assessments, and so forth. An assessment, for instance, can be a questionnaire requesting feedback, a survey, or a test (e.g., graded or non-graded); yet, the claimed subject matter is not so limited.

The assembly component 116 combines one or more assets from the library 114 to include in an information assemblage. The one or more assets combined by the assembly component 116 can be selected based at least in part upon input received from the creator device 104. According to an example, at least one asset can be suggested for inclusion in the information assemblage. For instance, the suggestion can be provided to the creator device 104; hence, the suggestion can prompt subsequent input from the creator device 104.

Moreover, the assembly component 116 can organize the information assemblage. By way of example, the assembly component 116 can specify a consumption order for the assets included in the information assemblage. According to another example, the assembly component 116 can organize visual indicators (e.g., icons, lists, etc.) representative of the assets included in the information assemblage. The assembly component 116 can further specify the target devices 108-112 for inclusion in the target audience 106 to which the information assemblage is disseminated. The assembly component 116, for instance, can perform the foregoing operations at least in part in response to input received from the creator device 104.

Moreover, the message system 102 includes a monitor component 120 that obtains feedback from the target audience 106 related to the information assemblage disseminated by the distribution component 118. The monitor component 120 tracks the feedback from the target audience 106 in real time. For example, the monitor component 120 monitors how much of the information assemblage has been consumed by the target devices 108-112 in the target audience 106. Further, the monitor component 120 collects responses to assessment(s) included in the information assemblage. The monitor component 120 can also detect how the information assemblage is consumed (e.g., device type used for consumption), a length of time over which the information assemblage is consumed, whether the information assemblage is shared with other device(s) (e.g., included in the target audience 106, outside the target audience 106, etc.), a number of times that the information assemblage is shared, and so forth.

The feedback collected by the monitor component 120 related to the information assemblage created and sent by the creator device 104 is accessible to the creator device 104 through the secure web-based portal. For instance, a dashboard that provides information related to the feedback can be rendered on a display of the creator device 104 (or a display of a device of an administrator, supervisor, etc.). According to an example, through the dashboard, whether an asset has been viewed, a question has been answered, or any other information related to interaction between the target devices 108-112 and the information assemblage can be viewed. Thus, the dashboard can supply a real time push of information related to the feedback. By way of illustration, the dashboard can be leveraged to see that a first user employing target device 1 108 has not opened the information assemblage, a second user employing target device 2 110 has completed task two out of five from the information assemblage, and so forth. Hence, in real time, a creator can know how the target audience 106 is interacting with the information assemblage.

Feedback collected by the monitor component 120 corresponding to the information assemblage disseminated by the distribution component 118 can be retained in a data store 122. The data store 122 can also retain feedback collected by the monitor component 120 corresponding to previously disseminated information assemblage(s) sent by the message system 102. Collected feedback stored in the data store 122 can pertain to previously disseminated information assemblage(s) created and sent by the creator device 104. It is also contemplated that collected feedback stored in the data store 122 can relate to previously disseminated information assemblage(s) created and sent by differing creator device(s) (e.g., disparate user(s)); however, the claimed subject matter is not so limited.

The message system 102 can further include a control component 124 that sets and enforces controls for the information assemblage. For example, the control component 124 can control who (e.g., user, target device, etc.) can view the information assemblage or a particular asset included in the information assemblage, a type of device that can be utilized to consume the information assemblage or the particular asset of the information assemblage, whether the information assemblage can be forwarded, to whom the information assemblage can be forwarded, and/or an order of consumption of the assets included in the information assemblage. By way of further example, the control component 124 can enforce requirements set to dictate when a target device can progress from consumption of one asset in the information assemblage to another asset in the information assemblage. Pursuant to yet another example, the control component 124 can control whether an asset can be downloaded to a target device. According to further examples, the control component 124 can restrict access to the information assemblage or the particular asset of the information assemblage based upon a location of a target device, a time during which access is attempted, or the like.

The creator device 104 and the target devices 108-112 can be substantially any types of computing devices. By way of example and not limitation, the creator device 104 can be a personal computer, laptop, tablet, smartphone, handheld, gaming device, or the like. Similarly, the target devices 108-112 can be one or more of personal computers, laptops, smartphones, handhelds, gaming devices, and so forth.

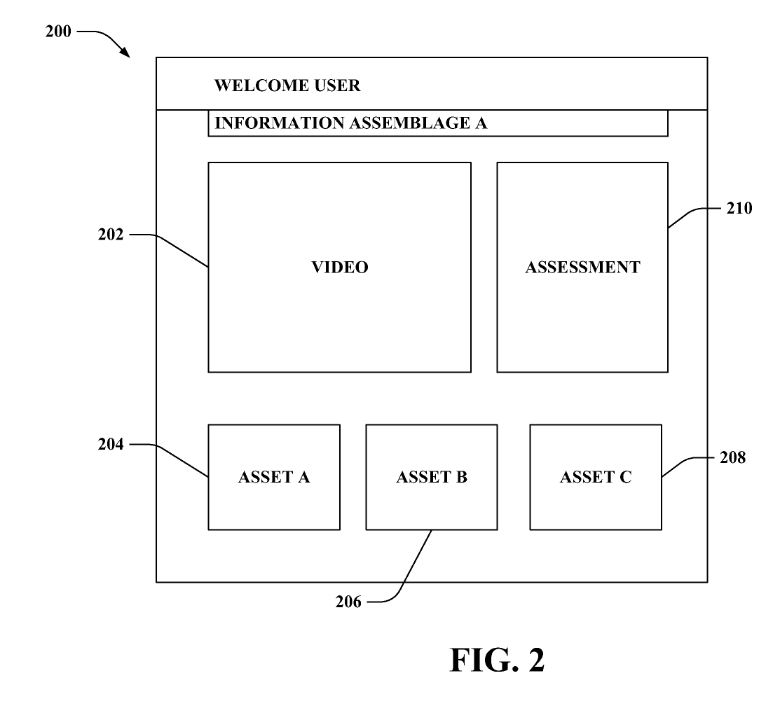

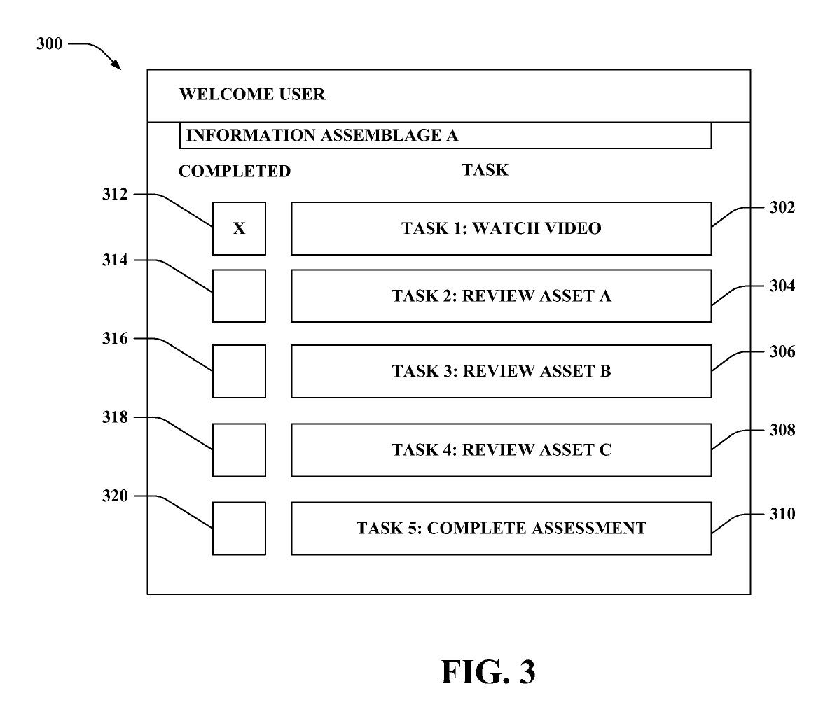

With reference to FIGS. 2-3, illustrated are example graphical user interfaces that can be provided by the message system 102 to a target device (e.g., target device 1 108, target device 2 110, . . . , target device X 112) via a secure web-based portal. The graphical user interfaces display an information assemblage (e.g., Information Assemblage A) generated by the message system 102 and disseminated to the target device. The target device can access the message system 102 via a secure web-based portal, and a graphical user interface, such as one of the graphical user interfaces from FIG. 2 or FIG. 3, can be rendered on a display of the target device. It is contemplated that the graphical user interfaces shown in FIGS. 2-3 are provided as examples, and the claimed subject matter is not so limited. For instance, a graphical user interface with a differing layout is intended to fall within the scope of the hereto appended claims.

The Information Assemblage A depicted in FIGS. 2-3 includes five assets: a video 202, an asset A 204, an asset B 206, an asset C 208, and an assessment 210. The Information Assemblage A is generated and distributed by the message system 102 as described herein. Assets 204-208 can each respectively be any type of asset (e.g., video information, image information, audio information, documents, assessments, etc.). It is to be appreciated, however, that the claimed subject matter is not limited to the example Information Assemblage A described in FIGS. 2-3. For instance, an information assemblage can include more than or fewer than five assets. Further, it is contemplated that an information assemblage need not include a video and/or an assessment.

Turning to FIG. 2, illustrated is a graphical user interface 200 that depicts the Information Assemblage A rendered on a display of the target device. The graphical user interface 200 provides real estate that is divided into respective regions for assets of the Information Assemblage A. An asset can be rendered in a corresponding region of the graphical user interface 200 (e.g., the video 202 can be displayed as part of the graphical user interface 200). Additionally or alternatively, an indicator associated with an asset, such as an icon, can be rendered in a corresponding region of the graphical user interface 200, and upon selection of the indicator, the asset can be displayed (e.g., in the corresponding region, in a disparate window that can open on the display, etc.).

According to an illustration, the video 202, asset A 204, asset B 206, and/or asset C 208 can be opened, viewed, and so forth. The video 202, asset A 204, asset B 206, and/or asset C 208 can convey information to a user of the target device. Moreover, the user of the target device can supply responses to the assessment 210. The user of the target device can also input user ratings, annotations, etc. related to one or more of the assets 202-210.

An order of consumption of the assets of the Information Assemblage A can be controlled (e.g., by the control component 124). Thus, the video 202 can be set to be a first asset consumed by the target device, followed by the asset A 204, and so forth. For example, if the order of consumption is controlled, an asset to be consumed can be highlighted in some manner to draw attention to that asset. However, it is also contemplated that the order of consumption need not be controlled.

As the Information Assemblage A is consumed by the user of the target device, the monitor component 120 of the message system 102 can track the consumption of the Information Assemblage A by the target device. For example, the monitor component 120 can detect whether the video 202 or assets 204-208 (or a portion thereof) have been opened and viewed with the target device. According to a further example, the monitor component 120 can collect the responses to the assessment 210. Consumption of the Information Assemblage A by the target device can be tracked in real time.

Now referring to FIG. 3, illustrated is another graphical user interface 300 that depicts the Information Assemblage A rendered on a display of the target device. The graphical user interface 300 displays a list of tasks. According to the illustrated example, the graphical user interface 300 includes Task 1: Watch Video 302, Task 2: Review Asset A 304, Task 3: Review Asset B 306, Task 4: Review Asset C 308, and Task 5: Complete Assessment 310. Pursuant to this example, the video included in the Information Assemblage A is to be watched first, followed by review of asset A, review of asset B, and review of asset C, and thereafter the assessment is to be completed.

Upon completion of a task, an indicator corresponding to the task can signify completion via the graphical user interface 300. As shown, the graphical user interface 300 includes an indicator 312 corresponding to task 1, an indicator 314 corresponding to task 2, an indicator 316 corresponding to task 3, an indicator 318 corresponding to task 4, and an indicator corresponding to task 5. Hence, when Task 1: Watch Video 302 is completed, the indicator 312 can specify such completion in substantially any manner (e.g., the illustrated example shows that Task 1: Watch Video 302 has been completed). The indicators 312-320 can automatically be checked upon completion of a task, for instance. Additionally or alternatively, the indicators 312-320 can manually be checked.

The graphical user interface 300 specifies an order for the list of tasks 302-310. For instance, Task 1: Watch Video 302 can be selected and the video included in the Information Assemblage A can be displayed. While the video is playing or after the video plays, annotation to the video can be offered from the target device. Moreover, an annotation from another user can be viewed before, during or after viewing of the video. When viewing of the video is completed, the indicator 312 can signify that Task 1: Watch Video 302 has been completed. Thereafter, a next task (e.g., Task 2: Review Asset A 304) can be selected in response to input from the target device.

According to another example, it is to be appreciated that a task can automatically launch. Thus, if Task 1 302 and Task 2 304 have been completed, Task 3: Review Asset B 306 can automatically begin. Yet, the claimed subject matter is not limited to the foregoing example.

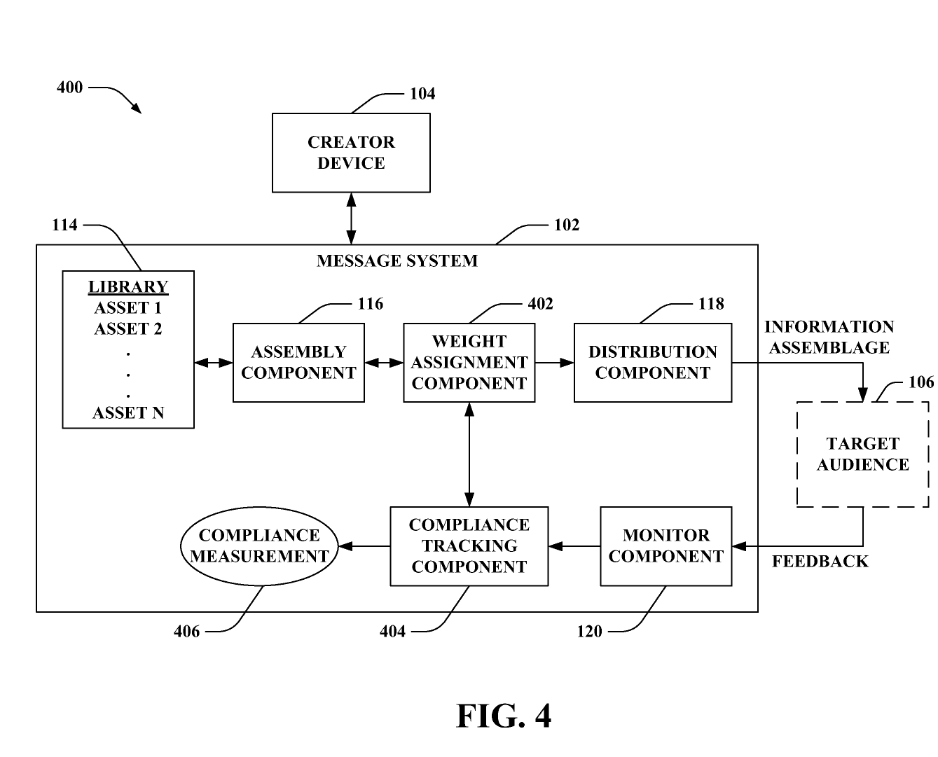

With reference to FIG. 4, illustrated is a system 400 that measures compliance using an information assemblage. The system 400 includes the message system 102, the creator device 104, and the target audience 106. The message system 102 includes the assembly component 116 that can form an information assemblage that includes a plurality of assets from the library 114. Moreover, the message system 102 can include a weight assignment component 402 that selects a subset of the plurality of assets from the information assemblage and assigns respective weights to assets in the subset. Information concerning the assets included in the selected subset and the respective weights assigned to the assets in the selected subset can be provided to a compliance tracking component 404 of the message system 102. Further, the message system 102 includes the distribution component 118 that disseminates the information assemblage to the target audience 106.

Target device(s) (e.g., the target devices 108-112) in the target audience 106 can consume the information assemblage. As the information assemblage is consumed by the target device(s) in the target audience 106, the monitor component 120 can monitor feedback related to the information assemblage. The feedback related to the information assemblage can be analyzed by the compliance tracking component 404. For example, the compliance tracking component 404 can evaluate metrics for the assets in the selected subset from the feedback. Moreover, the compliance tracking component 404 can generate a compliance measurement 406 by combining results of the metrics for the assets in the selected subset as a function of the respective weights.

The compliance measurement 406 can correspond to a particular target device (e.g., associated with a particular user) in the target audience 106. Further, the compliance tracking component 404 can yield a respective compliance measurement for each target device in the target audience 106. Moreover, it is to be appreciated that the compliance measurement 406 can be for a group of target devices (e.g., group of users); yet, the claimed subject matter is not so limited.

Moreover, the compliance measurement 406 yielded by the compliance tracking component 404 can be updated in real time as the feedback related to the information assemblage is monitored by the monitor component 120. For instance, as an asset included in the information assemblage is consumed or an assessment included in the information assemblage is completed, the monitor component 120 can receive feedback. As the feedback is received, the compliance tracking component 404 can update the compliance measurement 406.

The weight assignment component 402 can select the subset of assets from the information assemblage that are considered by the compliance tracking component 404 for generation of the compliance measurement 406. The weight assignment component 402 can select the assets in the subset in response to an input received by the message system 102 from the creator device 104. According to an example, an information assemblage can be yielded by the assembly component 116 that includes a video, an image, two documents, and an assessment with five questions. Following this example, the video, one of the two documents, and the assessment can be selected for consideration by the compliance tracking component 404. Pursuant to another illustration, a subset of the questions of the assessment can be selected for consideration by the compliance tracking component 404. It is to be appreciated, however, that the claimed subject matter is not limited to the foregoing example.

According to another example, the weight assignment component 402 can suggest one or more assets of the information assemblage to select for consideration by the compliance tracking component 404. The suggestion of the one or more assets, for instance, can be provided to the creator device 104 when the creator device 104 is forming the information assemblage for dissemination to the target audience 106. The suggestion yielded by the weight assignment component 402, for example, can be generated by the weight assignment component 402 based on a global setting, an individual setting, previously disseminated information assemblages, measures of compliance generated from the previously disseminated information assemblages, and so forth.

Moreover, the weight assignment component 402 can assign respective weights to the assets in the selected subset. The respective weights can be assigned by the weight assignment component 402 in response to input received by the message system 102 from the creator device 104. Again, reference is made to the example of the information assemblage that includes the video, the image, the two documents, and the assessment with five questions, where the video, one of the two documents, and the subset of the questions of the assessment are selected for consideration by the compliance tracking component 404. Following this example, the weight assignment component 402 can assign respective weights to the video, the one document that is selected, and the questions of the assessment that are included in the subset.

Pursuant to a further example, the weight assignment component 402 can suggest a weight to be assigned to a given asset in the selected subset. For instance, the suggestion of the weight can be provided to the creator device 104 when the creator device 104 is forming the information assemblage for dissemination to the target audience 106. The suggestion yielded by the weight assignment component 402, for example, can be generated by the weight assignment component 402 based on a global setting, an individual setting, previously disseminated information assemblages, measures of compliance generated from the previously disseminated information assemblages, and so forth.

The compliance tracking component 404 uses information concerning the selected assets of the information assemblage and the respective weights for such assets to generate the compliance measurement 406. The compliance tracking component 404 evaluates metrics for the selected assets of the information assemblage from feedback collected by the monitor component 120 from the target audience 106. Moreover, the compliance tracking component 404 generates respective measures of compliance for recipients in the target audience by combining results of the metrics for the selected assets of the information assemblage as a function of the respective weights.

The compliance tracking component 404 can analyze various metrics for a particular asset (e.g., the selected assets) of the information assemblage from the feedback. Below are various example metrics that the compliance tracking component 404 can evaluate. It is to be appreciated, however, that other metrics are intended to fall within the scope of the hereto appended claims.

According to an example, the compliance tracking component 404 can detect whether the particular asset in the information assemblage is opened based on the feedback.

Pursuant to a further example, the compliance tracking component 404 can detect whether at least a predefined portion of the particular asset is viewed based on the feedback. According to an illustration, the compliance tracking component 404 can determine whether a given slide of a slideshow, a given page of a document, etc. is viewed upon a target device (e.g., by a user) in the target audience 106.

By way of another example, the compliance tracking component 404 can detect whether a response to a particular asset is received in the feedback. For instance, the compliance tracking component 404 can identify that an answer to a question of an assessment has been received, a user rating of an asset has been received, or the like.

Moreover, the compliance tracking component 404 can identify a specific response to the particular asset that is received in the feedback. In accordance with an illustration, a response to a true/false or multiple choice question included in the assessment can be analyzed. For instance, the compliance tracking component 404 can grade the response to the question.

Further, the compliance tracking component 404 can detect whether the information assemblage is shared based on the feedback. According to this example, the information assemblage can be disseminated by the distribution component 118 to user 1 (e.g., included in the target audience 106). If the information assemblage is forwarded to user 2, then the compliance tracking component 404 can recognize such sharing. Moreover, the manner by which the information assemblage is shared can be tracked by the compliance tracking component 404 from the feedback. For instance, the compliance tracking component 404 can identify that the information assemblage is shared via near field communication, Bluetooth, etc. between target devices. Further, a number of times that the information assemblage is shared, a number of target devices to which the information assemblage is shared, or with whom the information assemblage is shared can be detected by the compliance tracking component 404. Hence, downstream distribution of the information assemblage can be tracked and controlled by the message system 102. It is to be appreciated that sharing permissions can be maintained and enforced by the control component 124 of the message system 102.

According to yet another example, the compliance tracking component 404 can detect a type of device used to consume the particular asset or the information assemblage that includes the particular asset based on the feedback. For instance, consumption using a lifestyle device (e.g., tablet), computer (e.g., desktop, laptop, etc.), or smartphone can be distinguished.

Further, the compliance tracking component 404 can recognize a user rating for the particular asset received in the feedback. Hence, a user that consumes the particular asset with the target device can input a rating for the particular asset.

In accordance with yet a further example, for a video included in the information assemblage, the compliance tracking component 404 can evaluate one or more of the following metrics. Based on the feedback, the compliance tracking component 404 can detect whether a given range of frames of the video are viewed. Additionally or alternatively, based on the feedback, the compliance tracking component 404 can detect whether a key frame of the video is viewed. Pursuant to an illustration, the compliance tracking component 404 can identify that a user consumed a sufficient amount of the video if she views at least through the key frame (e.g., at a predetermined time) in the video or the given range of frames.

According to an illustration, an information assemblage that includes a plurality of assets, including an assessment, can be distributed to a target device. The monitor component 120 can receive feedback from the target device related to the information assemblage. For instance, the compliance tracking component 404 can use the feedback and tabulate a compliance measurement for the target device (e.g., for a user of the target device). Hence, the compliance tracking component 404 can interpret the feedback returned from the target device.

By way of example, the weight assignment component 402 can define respective weights for a subset of questions included in an assessment of an information assemblage. The respective weights can relate to how much the corresponding question relates towards meeting compliance. Hence, the respective weights can be based on relative importance. Pursuant to an illustration, a threshold level can be set; the compliance tracking component 404 can detect that compliance is met when the compliance measurement 406 is above the threshold level, while compliance is not met when the compliance measurement 406 is below the threshold level. It is to be appreciated, however, that any other manner of analyzing compliance can be utilized by the compliance tracking component 404 (e.g., percentage of compliance, star rating, etc.).

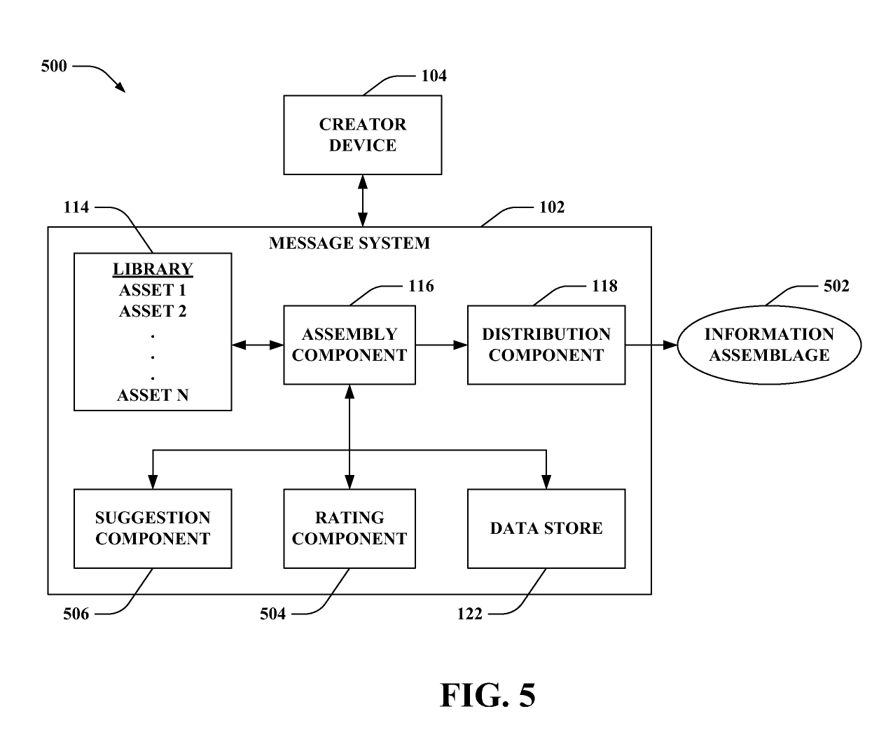

Referring to FIG. 5, illustrated is a system 500 that forms an information assemblage 502 for dissemination to a target audience (e.g., the target audience 106). The system 500 includes the message system 102, which further comprises the library 114, the assembly component 116, the distribution component 118, and the data store 122. The assembly component 116 can form the information assemblage 502 with a subset of the assets from a set of assets retained in the library 114. Moreover, the distribution component 118 can distribute the information assemblage 502 to the target audience.

The message system 102 can further include a rating component 504 and a suggestion component 506. The rating component 504 generates weighted ratings corresponding to characteristics of assets in the set of assets retained in the library 114 based at least in part upon feedback history (e.g., collected by the monitor component 120) retained in the data store 122. Moreover, the suggestion component 506 yields a suggestion from the weighted ratings corresponding to the characteristics of the assets in the set of assets retained in the library 114.

The rating component 504 can generate the weighted ratings from feedback history retained in the data store 122. The feedback history can include feedback corresponding to previously distributed information assemblages and/or feedback corresponding to assets included in the previously distributed information assemblages. Additionally or alternatively, the rating component 504 can generate the weighted ratings from global settings and/or individual settings. The global settings and/or the individual settings can be retained in the data store 122, for instance; however, the claimed subject matter is not so limited.

According to an example, a global setting can apply to users of the message system 102 (e.g., users that create information assemblages using the message system 102), users in an organization that leverages the message system 102, or the like. Further, an individual setting can apply to a particular user (e.g., specifically for the user of the creator device 104).

For example, the rating component 504 can generate the weighted ratings at least in part based on the feedback history retained in the data store 122. Accordingly, the rating component 504 can evaluate metrics upon the feedback from respective target audiences for the previously distributed information assemblages and the assets included in the previously distributed information assemblages. Moreover, the rating component 504 can combine results of the metrics for the previously distributed information assemblages and the assets included in the previously distributed information assemblages according to respective weights to yield respective weighted ratings for the previously distributed information assemblages and the assets included in the previously distributed information assemblages. Further, the rating component 504 can assign the respective weighted ratings to characteristics of the previously distributed information assemblages and the assets included in the previously distributed information assemblages.

Various metrics can be evaluated by the rating component 504. Below are example metrics that can be analyzed by the rating component 504; however, it is to be appreciated that other metrics are intended to fall within the scope of the hereto appended claims.

According to an example, the rating component 504 can detect whether a particular asset in a particular information assemblage is opened based on the feedback.

By way of another example, the rating component 504 can detect whether at least a predefined portion of the particular asset is viewed based on the feedback. For instance, the rating component 504 can determine whether a given slide of a slideshow, a given page of a document, etc. is viewed upon a target device.

In accordance with another example, the rating component 504 can detect whether a response to the particular asset is received in the feedback. For instance, the rating component 504 can identify that an answer to a question of an assessment has been received, a user rating for the particular asset has been supplied, or the like.

The rating component 504 can also detect a response rate for the particular asset or the particular information assemblage based on the feedback, for example. The response rate can be based on a number of users that consume the particular asset or the particular information assemblage, a number of users that answer questions included in an assessment of the particular information assemblage, and so forth.

According to yet another example, the rating component 504 can determine a percentage of the particular information assemblage that is consumed based on the feedback. For instance, the rating component 504 can identify a percentage of the assets of the particular information assemblage that are consumed, a percentage of questions included in an assessment of the particular information assemblage that are answered, or the like.

Further, the rating component 504 can identify a specific response to the particular asset that is received in the feedback. For instance, the rating component 504 can grade responses to questions included in an assessment. The rating component 504 can also determine a percentage of the questions that are answered correctly.

Moreover, the rating component 504 can detect whether the particular information assemblage is shared based on the feedback. By way of illustration, the rating component 504 can recognize that the particular information assemblage is shared by a user. Hence, the rating component 504 can detect a manner by which the particular information assemblage is shared, a number of times that the particular information assemblage is shared, a number of target devices to which the information assemblage is shared, with whom the particular information assemblage is shared, or the like.

The rating component 504 can also detect a type of device used to consume the particular asset or the particular information assemblage based on the feedback. For instance, the rating component 504 can distinguish between consumption of the particular asset or the particular information assemblage using a lifestyle device (e.g., tablet), computer (e.g., desktop, laptop, etc.), or smartphone.

By way of another example, the rating component 504 can recognize a user rating for the particular asset received in the feedback. Hence, a user that consumes the particular asset with the target device can input a rating for the particular asset, which can be identified by the rating component 504.

In accordance with yet a further example, the rating component 504 can identify a rating or setting associated with the creator device 104 (e.g., user of the creator device 104) of the particular information assemblage or a global setting.

In accordance with another example, for a video included in a particular information assemblage, the rating component 504 can evaluate one or more of the following metrics. Based on the feedback, the rating component 504 can detect whether a given range of frames of the video are viewed. Additionally or alternatively, based on the feedback, the rating component 504 can detect whether a key frame of the video is viewed.

The rating component 504 can analyze one or more metrics upon the feedback for a previously distributed information assemblage or an asset included in a previously distributed information assemblage. Further, the rating component 504 can combine results of the one or more metrics according to respective weights (e.g., corresponding to the metrics) to yield a weighted rating for the previously distributed information assemblage or the asset included in the previously distributed information assemblage. Moreover, the rating component 504 can assign the weighted rating to characteristics of the previously distributed information assemblage or the asset included in the previously distributed information assemblage. It is further contemplated that the rating component 504 can update the weighted ratings for the characteristics in real time as previously distributed information assemblages and assets included in the previously distributed information assemblages are consumed or completed by recipients in the respective target audiences.

Weighted ratings can be assigned to various characteristics of an asset or an information assemblage. According to an example, a characteristic can be a length of a video in an information assemblage, a number of questions in an assessment included in an information assemblage, types of questions in the assessment included in the information assemblage, a number of assets in the information assemblage, types of assets in the information assemblage, order of presentation of assets in the information assemblage, consumption order specified for the assets in the information assemblage, identity of assets in the information assemblage, or the like. Moreover, it is to be appreciated that other characteristics are intended to fall within the scope of the claimed subject matter.

The suggestion component 506 can generate a suggestion based upon the weighted ratings yielded by the rating component 504. The suggestion component 506 can generate the suggestion for the information assemblage 502 being created by the assembly component 116. For instance, the suggestion can be disseminated to the creator device 104.

The suggestion supplied by the suggestion component 506 can specify a subset of the characteristics to leverage in the information assemblage 502 being created by the assembly component 116. By way of further example, the suggestion yielded by the suggestion component 506 can indicate an asset to add to the information assemblage 502 being formed by the assembly component 116. In accordance with another example, the suggestion generated by the suggestion component 506 can specify an asset to exclude from the information assemblage 502 being created by the assembly component 116. Additionally or alternatively, the suggestion component 506 can suggest an order of assets in the information assemblage 502 being formed by the assembly component 116, for example. By way of yet a further example, the suggestion supplied by the suggestion component 506 can indicate edits of an asset to be added to the information assemblage 502 being formed by the assembly component 116 (e.g., suggesting a change of a length of a video, alteration of number/type of questions included in an assessment, modification of a document, etc.).

The following sets forth an illustration by which the suggestion component 506 can yield the suggestion. The suggestion component 506 can detect criteria for the information assemblage 502 being formed by the assembly component 116. For example, a first asset (e.g., a magnet asset) can be added to the information assemblage being formed (e.g., in response to input received from the creator device 104). Following this example, the suggestion component 506 can detect the criteria from the first asset added to the information assemblage 502 being formed. Additionally or alternatively, the suggestion component 506 can detect the criteria from an identity of a creator (e.g., associated with the creator device 104) of the information assemblage 502 being formed. For example, the criteria can be one or more of a target audience for the information assemblage 502 being formed, a purpose of the information assemblage 502 being formed, viewing preferences of the target audience of the information assemblage 502 being formed, and the like. Based upon the detected criteria, the suggestion component 506 can generate the suggestion for a subset of the characteristics.

According to an illustration, the creator device 104 can add a video to an information assemblage being formed with the assembly component 116. Thereafter, the suggestion component 506 can suggest a question to include in an assessment based on the video. Additionally or alternatively, if a first question is added to an assessment included in the information assemblage along with the video, the suggestion component 506 can suggest a second question based on the first question and the video. For instance, the suggestion component 506 can compare the first question and the second question, and identify that the second question is statistically more effective. Hence, the suggestion component 506 can suggest replacing the first question with the second question, inserting the second question before the first question in the assessment, and so forth.

Based on past results, intelligence can be built using the rating component 504 which can enable the suggestion component 506 to supply suggestions. The suggestions yielded by the suggestion component 506 can assist the creator device 104 in forming more effective information assemblages.

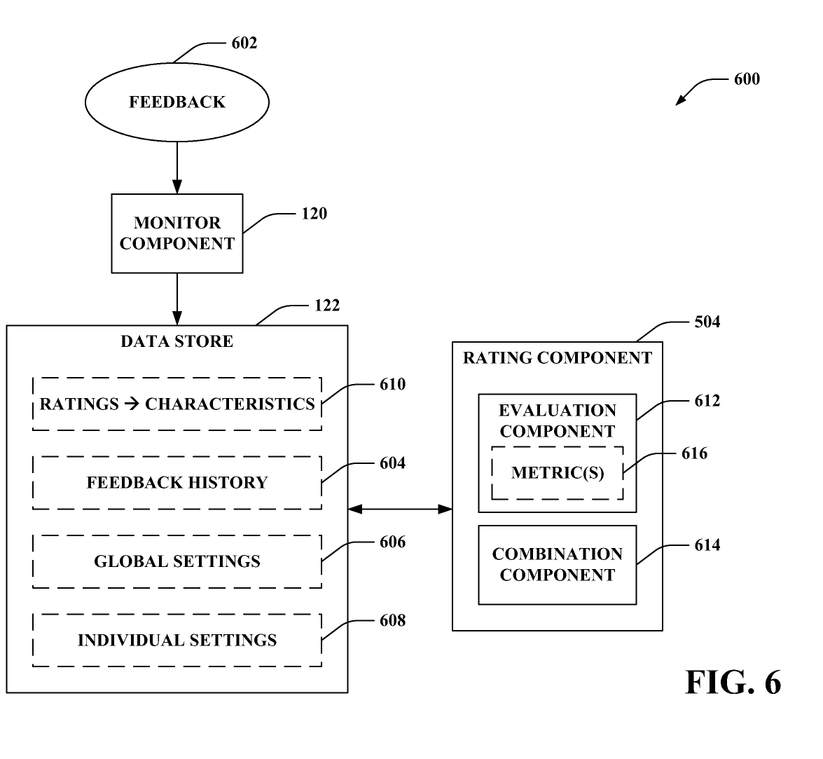

Now referring to FIG. 6, illustrated is a system 600 that generates weighted ratings according to various aspects described herein. The system 600 includes the monitor component 120, the data store 122, and the rating component 504. The monitor component 120 collects feedback 602 related to information assemblages that are disseminated. The monitor component 120 obtains the feedback 602 from respective target audiences to which the information assemblages are disseminated. Moreover, the monitor component 120 can store the feedback in the data store 122 as feedback history 604.

The data store 122 can retain the feedback history 604. The feedback history 604 can include feedback corresponding to previously distributed information assemblages, feedback corresponding to assets included in the previously distributed information assemblages, and so forth. Further, the data store 122 can retain global settings 606 and individual settings 608. Moreover, the data store can retain weighted ratings for characteristics 610. The weighted ratings for the characteristics 610 can be generated by the rating component 504.

The rating component 504 can comprise an evaluation component 612 and a combination component 614. The evaluation component 612 can evaluate one or more metrics 616 upon the feedback history 604. Further, depending upon the metric 616, the evaluation component 612 can utilize the global settings 606 and/or the individual settings 608 when analyzing the one or more metrics 616. Moreover, the combination component 614 can combine results of the one or more metrics 616 yielded by the evaluation component 612. The combination component 614 can combine the results of the metrics according to respective weights to yield respective weighted ratings. The respective weighted ratings can be assigned to characteristics and retained in the data store 122.

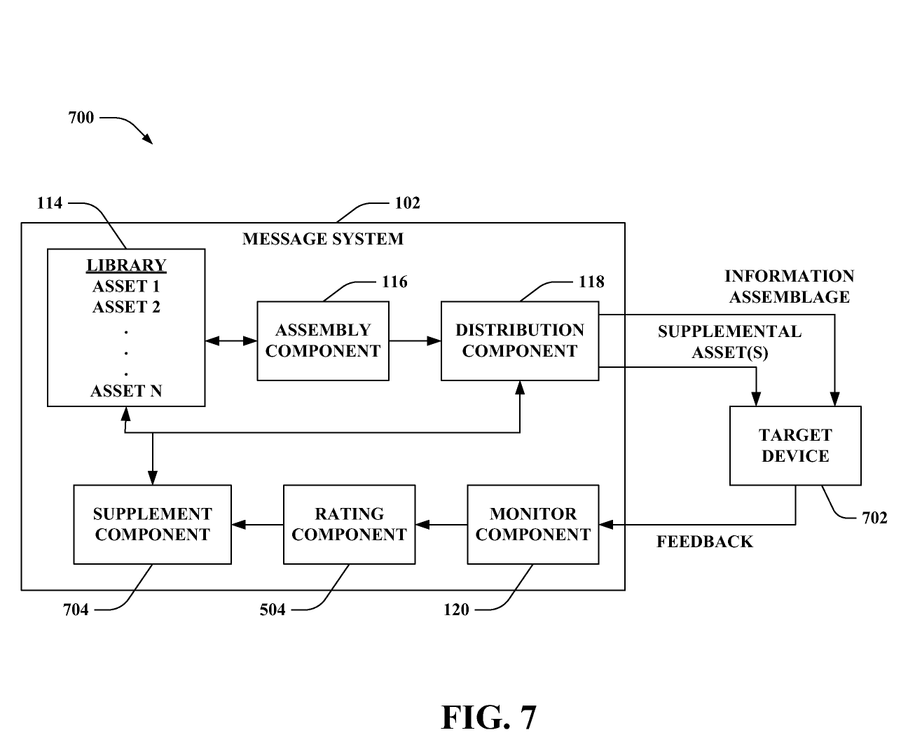

With reference to FIG. 7, illustrated is a system 700 that supplies supplemental asset(s) in addition to assets included in an information assemblage. The system 700 includes the message system 102. The message system 102 includes the library 114, the assembly component 116, and the distribution component 118. For instance, the assembly component 116 can form an information assemblage that includes a plurality of assets retained in the library 114. Moreover, the distribution component 118 can disseminate the information assemblage to a target audience.

The target audience can include a target device 702. Accordingly, the information assemblage can be distributed to the target device 702. Moreover, feedback can be provided from the target device 702 to the monitor component 120 of the message system 102.

The message system 102 can further include the rating component 504. The rating component 504 can generate weighted ratings associated with assets retained in the library 114. For example, the rating component 504 can generate the weighted ratings from one or more of global settings, individual settings, feedback corresponding to the information assemblage, feedback corresponding to previously distributed information assemblages, feedback corresponding to assets included in the information assemblage, feedback corresponding to assets included in the previously distributed information assemblages, and so forth.

The message system 102 can also include a supplement component 704 that selects a supplemental asset from the library 114 based upon the feedback from the target device 702 (e.g., obtained via the monitor component 120) and respective weighted ratings associated with the set of assets in the library 114 (e.g., generated by the rating component 504). According to an illustration, if the target device 702 consumes the information assemblage, the supplement component 704 can recognize such consumption. Hence, the supplement component 704 can choose a supplemental asset (or a plurality of supplemental assets) from the library 114 in response to feedback indicating that the information assemblage was consumed by the target device 702. Moreover, the supplemental asset selected from the library 114 by the supplement component 704 can be distributed to the target device 702. It is further contemplated that the supplement component 704 can continue to supply additional supplemental assets to the target device 702 as the supplemental assets are consumed by the target device 702.

The supplement component 704 enables more content (e.g., supplemental asset(s)) to be suggested to the target device 702. For example, based on assets presented to the target device 702 as part of the disseminated information assemblage, how the assets were consumed by the target device 702, user ratings related to the assets of the information assemblage received from the target device 702, responses to questions in an assessment of the information assemblage, etc., the supplement component 704 identifies additional asset(s) from the library 114 that may be of interest to a user of the target device 702. For instance, the supplement component 704 can use a combination of the weighted ratings yielded by the rating component 504, metatags, keywords, and so forth to yield the suggestions. According to an illustration, if the library 114 includes a number of videos with metatags for diabetes and feedback is received from the target device 702 indicating that a high user rating was assigned by the target device 702 to a video of a dietitian concerning diabetes included in the information assemblage, then the supplement component 704 can identify other videos with diabetes and/or dietitian as metatags, which have generally been highly rated, and suggest such videos as supplemental asset(s). The supplemental asset(s) can be supplied to the target device 702 to continue to provide assets for consumption by the target device 702 while logged into the message system 102.

Various example scenarios related to use of the message system 102 are set forth below. It is to be appreciated that these example scenarios are provided as examples, and the claimed subject matter is not limited to such example scenarios.

According to an example scenario, the message system 102 can be used in the financial sector. Financial requirements/regulations have become more rigorous from governing bodies down to individual business to consumer interactions. Financial institutions can leverage the message system 102, for example, in the areas of governance, risk management, and compliance.

With respect to governance, the amount of information to be translated to board leadership of their roles as organizational stewards is a requirement and can be daunting. New board members and current board members typically need to be advised at least annually of their fiduciary duties to the organization. These responsibilities can have legal and ethical ramifications. Targeted communications can come directly from CEOs, CFOs, legal counsel, etc. Accordingly, the message system 102 can record these communications. The message system 102 can enable these communications to be tracked and reported, while considering security, privacy and immediacy.

The message system 102 allows companies to track information sent, viewed, and received by board members. Back end analytics (e.g., supplied via a dashboard) can provide a tool to audit board understanding and track decision-making This can be useful for board members who keep schedules that are compressed with decision making for his/her own positions as well as that of the board position.

The message system 102 can demonstrate to compliance-making entities (e.g., by leveraging compliance tracking) how board members and senior staff leadership engage on key decision making pieces and receive up to date regulations. Utilization of the message system 102 to supply information assemblages that include multimedia communications coupled with key survey questions can provide evidence of receipt, viewing, engagement, questions, and feedback.

The message system 102 can be a useful tool for an organization to employ for governance and compliance in connection with federal laws such as, for instance, the Sarbannes-Oxley Act of 2002. Public boards are to comply with this law which addresses corporate responsibility, auditor independence, financial disclosure, monitoring conflicts of interest, corporate and criminal fraud, banking practices, corporate tax returns, executive compensation, executive performance, and board self monitoring. By way of example, boards commonly approve plans and decisions of the CEO, but doing so can make the board complicit in the decision and can draw the board in a part of the administration that they are supposed to monitor. For instance, a CEO can have a decision in front of the board. The CEO can use the message system 102 to create an information assemblage (e.g., a multimedia, video-based message) that details the key points. Moreover, the CEO can attach financial documents associated with alternatives to the information assemblage (e.g., employing the assembly component 116). The CEO can also attach another information assemblage from the CFO that describes the alternatives (e.g., employing the assembly component 116).

A particular order for viewing the assets of the information assemblage yielded by the CEO can be controlled. Thus, board members view the information assemblage in the particular order, including opening the associated attachments in the order as specified. Moreover, as the information assemblage to be disseminated to the board is being created, the message system 102 can attempt to assist the creator with intelligent suggestions (e.g., generated by the suggestion component 506). For instance, the suggestion component 506 can yield suggestions of an assessment, video attached to the information assemblage, etc. as well as how to rate the responses from viewers in the target audience. The suggestions can be stored feedback histories or default settings (e.g., individual settings and/or global settings) references against the assessment, the video, the information assemblage, etc. to find an optimized manner for the creator to effectively communicate to the board.

Below are example survey questions that can be included in the assessment generated by the CEO.

1) In your role as Trustee, do you agree that this action will result in keeping the organization fiscally viable?
Yes, I have read the full document and attached financial reports and support moving forward
No, I do not believe that this action is beneficial to the organization
I am not prepared to act, I need more information

2) Has the senior leadership made it clear what the financial risks are associated with this action?
Yes
No
I require more information before I am able to make an informed decision

3) What additional information do you require prior to the board meeting?

4) Does this action conflict with any of your personal or business financial relationships?
Yes
No

As a result of the feedback from the board members, the CEO, senior staff, etc. can gather additional information and gain a clear understanding prior to the meeting concerning where board members stand. By way another illustration, based on who, how often, and when board members accessed the information assemblages respectively disseminated to them, senior leadership can be able to tailor future messages, based on concentrated time on the information assemblage, types of questions answered, response types, etc. Hence, an effective form of targeted communication to board members can be optimized by leveraging the message system 102 (e.g., including selecting day and time to send the information assemblage, required lead time, etc.).

According to another example, the message system 102 can be employed in relation to home refinancing. With respect to home refinancing, a number of new requirements with refinancing come with extensive paperwork and explanation from both mortgage lenders and underwriters alike. The message system 102 can be leveraged to simplify the home refinancing process. For instance, dissemination of information assemblage(s) using the message system 102 can address the issue of language proficiency and reading fluidity of borrowers. Moreover, multilingual information assemblages can be sent.

Following this example, a broker or lender can create content (e.g., assets) that can be stored in the library 114. Further, the content can be added to an information assemblage via the assembly component 116. Moreover, forms to be completed by a borrower can also be added to the information assemblage by the assembly component 116. For instance, a lender commonly focuses on a checklist of items to be completed prior to moving forward with the refinancing; conventionally this is accomplished via phone or email. In contrast, with the message system 102, the broker is able to view in real time what has been viewed by the borrower and what has not been accessed by the borrower. Moreover, based on feedback that is returned (e.g., related to viewing, questions, responses, etc.) as collected by the monitor component 120 the lender can be able to craft more effective information assemblages for subsequent borrowers.

Below are examples of assets that can be included in an information assemblage generated and disseminated by a broker or lender.

A. Documents needed for refinance (to be uploaded by borrower)
1 Month Current Pay Stubs (Self Employed or Salaried)
2 Years W-2's (Self Employed or Salaried)
2 Years Personal and Business Returns (Self Employed Only)
Current Year Profit & Loss Statement (Self Employed Only)
Letter from Accountant Stating Length of Employment (Self Employed Only)
3 Months Savings and Checking Bank Accounts
Recent Quarter of Investment Retirement Accounts
12 Month Rent Checks (Front & Back) or Landlord Letter
Fully Executed Contract of Sale
Down Payment Check (Front & Back)
Name, Phone, Fax, Address of Attorney
Copy of Drivers License

B. Lender Privacy Policies

C. Definitions of Types of Loans Offered

Related Videos

A. Message from the Lender CEO on philosophy of lending/practices

B. Other important messages—Risk and Managing Credit

General Survey
1) When are you looking to refinance?
2) What state is the home located?
3) Is this your primary or secondary home?
4) What time frame are you looking to complete this transaction?
5) Have you already consulted another lender(s)?

According to another example scenario, the message system 102 can be used in the health care sector. The message system 102 can be used to educate patients prior to a hospital stay, preparation for discharge, and/or while at home after a health care procedure.

By way of illustration, a patient who will be having open-heart surgery conventionally is provided with extensive information pre-surgery, directly after the procedure, in preparation for discharge, at home, and in-between CT surgeon, cardiology, and primary care visits.

Prior to survey, an information assemblage can be disseminated to the patient using the message system 102. The information assemblage can be sent to the patient to mitigate errors in preparation for surgery, which can delay start times and result in more costly cases at the hospital. For example, the information assemblage sent prior to survey can include assets related to one or more of the following.
1. Specific instructions on how to prepare for surgery
2. What does NPO mean
3. How do you bathe with a sponge and anti-bacterial prior to surgery
4. The removal of facial hair prior to surgery
5. Proper documentation/form completion (which legal documents to bring with you)
6. No jewelry, dentures, etc.
7. What time to arrive
8. Where to go in the hospital
9. Where is parking for surgical patients

Moreover, the information assemblage can also include assets with information useful for family members of the patient. Accordingly, the information assemblage can be shared by the patient with a family member. Such information can include the following, for example.

For Family Members

1. Where to park

2. Where to wait

3. Where to eat

4. What to bring

5. Where to find quiet time

The information assemblage (or a separate information assemblage) can also include general information on the procedure itself, including an introduction to the surgeon (e.g., what does he look like, a picture of the surgeon, a video with the surgeon talking, etc.), information generally related to the procedure, and so forth.

The information assemblage (or disparate information assemblage(s)) can further include information related to after the procedure, preparing for discharge, and/or frequently asked questions.

After the Procedure
1. What might I expect?
2. What will they look like?
3. Where will the patient go?
4. How long will they stay in the hospital?
5. What floor will they go to?
6. What activities will they be allowed to do?
7. What can they eat?
8. Will they be in pain?
9. How will their pain be managed?

Preparing for Discharge
1. What activities may the patient do?
2. When can they drive?
3. What can they eat?
4. When should we go back and see a physician?
5. Who should we call with questions?
6. What is “normal”?

The information assemblage can additionally include survey questions, for example.

Survey Questions
1. Do you have specific questions about what you viewed?
2. Are you prepared for surgery?
3. Is there information that would have helped you prepare better for the surgery?
4. Is there information that would have helped you prepare for discharge?
5. What questions or issues did you have when you got home?
6. How is your rehabilitation progressing?

By disseminating information assemblages with the distribution component 118, collecting feedback from the patient with the monitor component 120, and generating compliance measurements with the compliance tracking component 404, the message system 102 can demonstrate to regulatory entities how patient educators and physicians engage patients on self help and care. Utilization of information assemblages, which can be multimedia communications coupled with survey questions, in the message system 102 can provide evidence of receipt, viewing, engagement, questions, and feedback. Accordingly, a hospital can be able to gauge how patients learn and retain valuable information. This feedback to physicians, for instance, can assist in crafting more meaningful programs that can result in better quality care and less costly care.

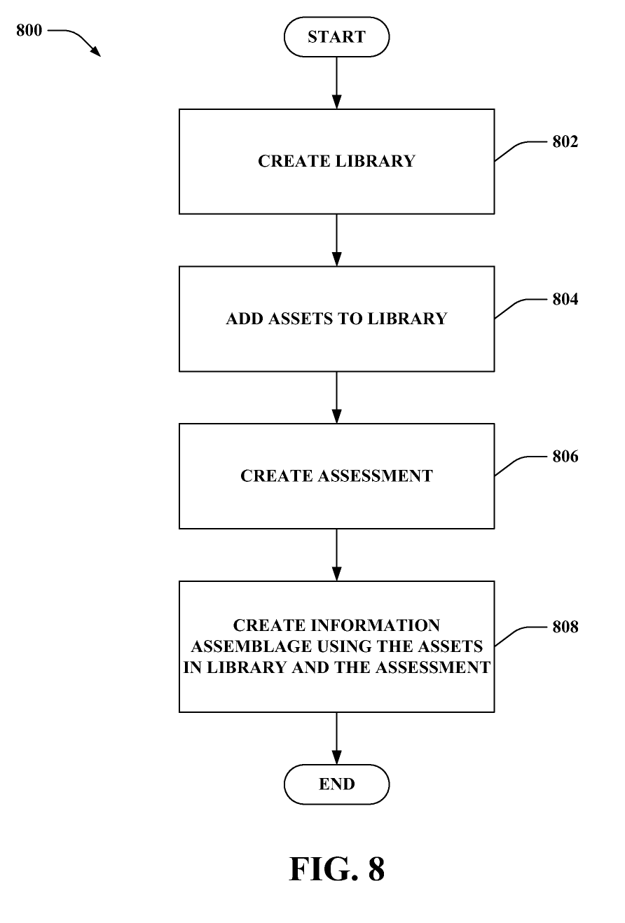

FIGS. 8-12 illustrate methodologies relating to generation and utilization of information assemblages. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, a subset of the illustrated acts may not be required to implement a methodology in accordance with one or more embodiments.

FIG. 8 illustrates a methodology 800 that facilitates generating an information assemblage. At 802, a library can be created. For instance, the library can be associated with a user. Moreover, the library can be created in response to input received from a creator device (e.g., device of the user), a system administrator, or substantially any other source. At 804, assets can be added to the library. Assets can be uploaded from the creator device. Additionally or alternatively, assets can be created in a message system (e.g., by the creator device). Moreover, assets can be automatically added to the library upon creating the library. It is to be appreciated that assets can be added to the library in substantially any manner, and the claimed subject matter is not limited to the foregoing examples. At 806, an assessment can be created. The assessment can include one or more questions. Further, it is to be appreciated that the assessment can be uploaded, retrieved from the library, or obtained in substantially any other manner. At 808, an information assemblage can be created using the assets in the library and the assessment.

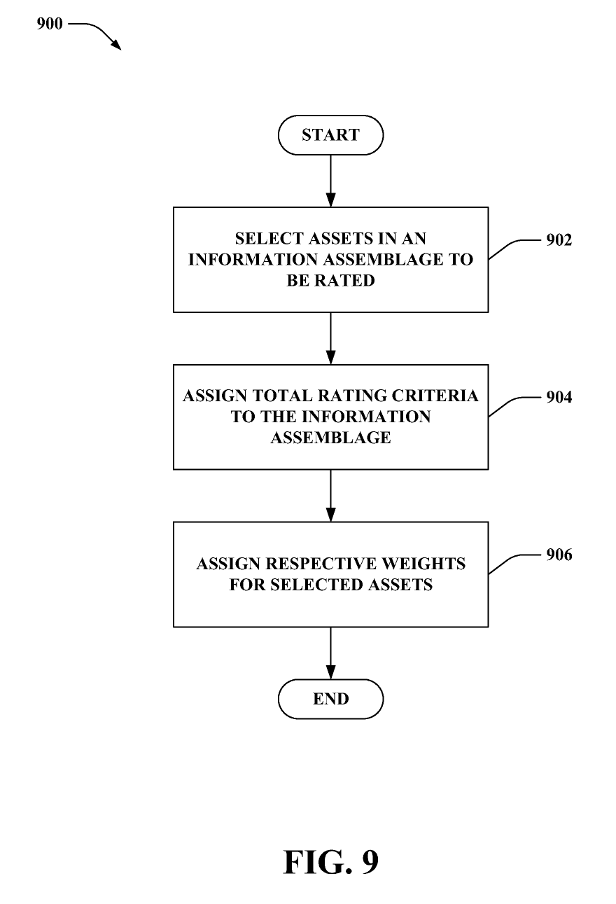

Turning to FIG. 9, illustrated is a methodology 900 that facilitates creating a custom rating system for assets of an information assemblage. At 902, assets in an information assemblage to be rated are selected. For instance, a subset of the assets included in the information assemblage can be chosen to be rated. At 904, total rating criteria can be assigned to the information assemblage. According to an example, the total rating criteria can be a star rating, a percentage rating, or the like. At 906, respective weights can be assigned for the selected assets. The weights can be assigned automatically and/or manually. Moreover, weights can be assigned generally to asset types; for instance, default weights can be assigned for video information versus audio information, etc. According to an illustration, as a default, video information can be assigned a higher weight compared to a text document, etc.; however, it is to be appreciated that the claimed subject matter is not so limited.

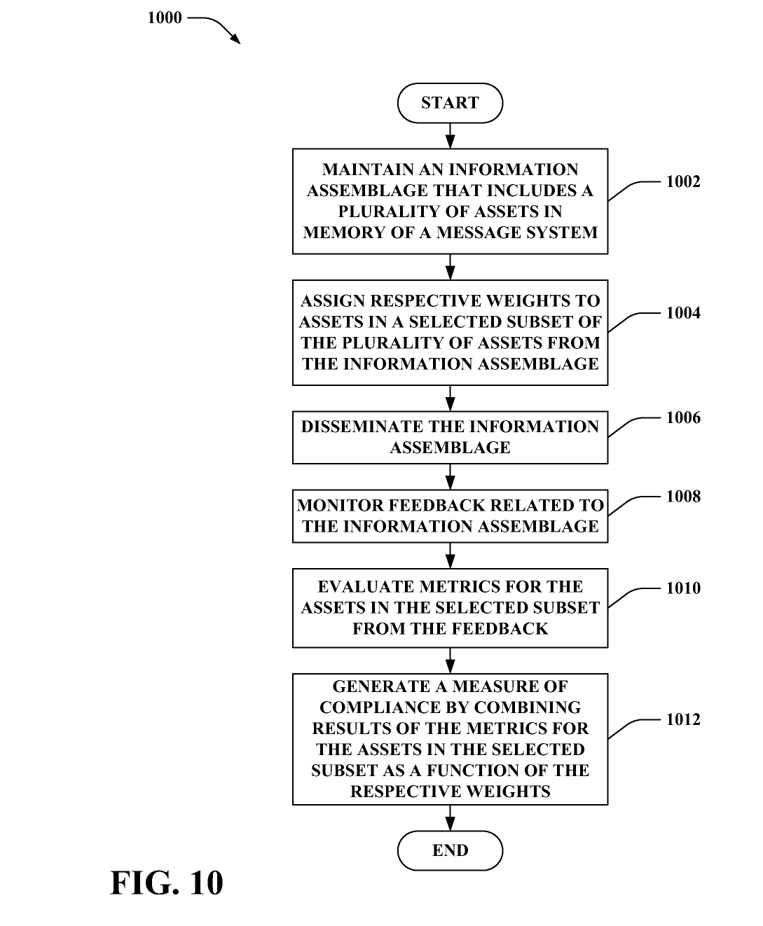

Now referring to FIG. 10, illustrated is a methodology 1000 of measuring compliance. At 1002, an information assemblage that includes a plurality of assets can be maintained in memory of a message system. The information assemblage can be maintained upon receiving the information assemblage at the message system (e.g., as an input from a creator device), for example. According to another example, the information assemblage can be maintained upon the information assemblage being formed based at least in part upon an input received by the message system. At 1004, respective weights can be assigned to assets in a selected subset of the plurality of assets from the information assemblage. For instance, an input can be received at the message system related to one or more assets to include in the selected subset of the plurality of assets from the information assemblage. At 1006, the information assemblage can be disseminated. For instance, the information assemblage can be disseminated to a target audience that includes a plurality of recipients. At 1008, feedback related to the information assemblage can be monitored. At 1010, metrics for the assets in the selected subset can be evaluated from the feedback. At 1012, a measure of compliance can be generated by comparing results of the metrics for the assets in the selected subset as a function of the respective weights. When the target audience to which the information assemblage is disseminated includes a plurality of recipients, respective measures of compliance corresponding to the plurality of recipients can be generated, for example. By way of another example, an overall measure of compliance for recipients in the target audience can be generated. Further, the measure of compliance can be updated in real time as the feedback related to the information assemblage is monitored.

Evaluating a particular metric for a particular asset can include one or more of the following. It is also contemplated that other metrics are intended to fall within the scope of the hereto appended claims. For instance, whether the particular asset in the information assemblage is opened can be detected based on the feedback. According to another example, whether at least a predefined portion of the particular asset is viewed can be detected based on the feedback. By way of a further example, whether a response to the particular asset is received can be detected in the feedback. In accordance with another example, a specific response to the particular asset that is received in the feedback can be identified. According to yet another example, whether the information assemblage is shared can be detected based on the feedback. Pursuant to a further example, a type of device used to consume the particular asset or the information assemblage can be detected based on the feedback. In accordance with another example, a user rating for the particular asset received in the feedback can be recognized. According to another example, a particular metric that can be evaluated for a video included in the information assemblage can include detecting whether a given range of frames of the video are viewed based on the feedback and/or detecting whether a key frame of the video is viewed based on the feedback.

According to a further example, a suggestion for a given asset from the plurality of assets of the information assemblage to select (e.g., at 1004) and/or a weight to be assigned to the given asset (e.g., at 1006) can be generated. The suggestion, for instance, can be provided to a creator device used to create the information assemblage. The suggestion can be generated based on one or more of a global setting, an individual setting, previously disseminated information assemblages, measures of compliance generated from the previously disseminated information assemblages, or the like.

Moreover, a suggestion concerning one or more of an asset to add to the information assemblage, an asset to exclude from the information assemblage, an order of assets in the information assemblage, potential edits of an asset to be added to the information assemblage, and so forth can be generated. Such suggestion, for example, can be provided to a creator device used to create the information assemblage. Thus, the suggestion can be leveraged when forming the information assemblage that includes the plurality of assets at 1002.

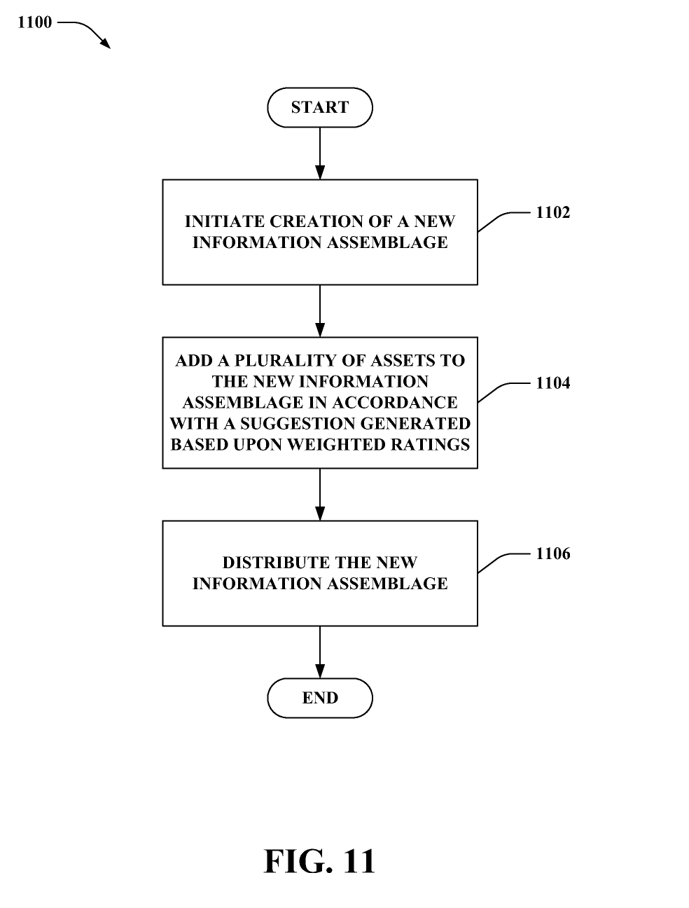

Turning to FIG. 11, illustrated is a methodology 1100 of forming a new information assemblage. At 1102, creation of the new information assemblage can be initiated. At 1104, a plurality of assets can be added to the new information assemblage in accordance with a suggestion generated based upon weighted ratings. For instance, the plurality of assets of the new information assemblage can include one or more asset types. For example, the one or more asset types can include one or more of video information, image information, audio information, documents, assessments, or the like. It is to be appreciated, however, that other asset types are intended to fall within the scope of the hereto appended claims. At 1106, the new information assemblage can be distributed.

According to an example, the weighted ratings can be generated from one or more of feedback corresponding to previously distributed information assemblages, feedback corresponding to assets included in the previously distributed information assemblages, global settings, individual settings, and so forth. Moreover, the weighted ratings can be generated by evaluating metrics upon the feedback from respective target audiences for the previously distributed information assemblages and the assets included in the previously distributed information assemblages, combining results of the metrics for the previously distributed information assemblages and the assets included in the previously distributed information assemblages according to respective weights to yield respective weighted ratings for the previously distributed information assemblages and the assets included in the previously distributed information assemblages, and assigning the respective weighted ratings to characteristics of the previously distributed information assemblages and the assets included in the previously distributed information assemblages.

Evaluating a particular metric can include one or more of the following. It is also contemplated that other metrics are intended to fall within the scope of the hereto appended claims. For instance, whether a particular asset in a particular information assemblage is opened can be detected based on the feedback. According to another example, whether at least a predefined portion of the particular asset is viewed can be detected based on the feedback. By way of a further example, whether a response to the particular asset is received in the feedback can be detected. According to yet another example, a response rate for the particular asset or the particular information assemblage can be detected based on the feedback. A percentage of the particular information assemblage that is consumed can also be determined based on the feedback, for example. Moreover, a specific response to the particular asset that is received in the feedback can be identified, for example. In accordance with another example, whether the particular information assemblage is shared can be detected based on the feedback. By way of another example, a type of device used to consume the particular asset or the particular information assemblage can be detected based on the feedback. According to another example, a user rating for the particular asset received in the feedback can be recognized. By way of a further example, a rating or setting associated with a creator of the particular information assemblage or a global setting can be identified. Pursuant to another example, a particular metric that can be evaluated for a video included in a particular information assemblage can include detecting whether a given range of frames of the video are viewed based on the feedback and/or detecting whether a key frame of the video is viewed based on the feedback.

The characteristics to which the respective weighted ratings are assigned can include one or more of video length in a particular information assemblage, number of questions in an assessment included in the particular information assemblage, types of questions in the assessment included in the particular information assemblage, number of assets in the particular information assemblage, types of assets in the particular information assemblage, order of presentation of assets in the particular information assemblage, consumption order specified for assets in the particular information assemblage, identity of assets in the particular information assemblage, or the like.

Further, the suggestion generated based upon weighted ratings for the new information assemblage can specify a subset of the characteristics to leverage in the new information assemblage. Moreover, the weighted ratings for the characteristics can be updated in real time as the previously distributed information assemblages and the assets included in the previously distributed information assemblages are consumed or completed by recipients in the respective target audiences.

According to another example, when creating the new information assemblage, criteria for the new information assemblage can be detected. Following this example, the suggestion for a subset of the characteristics can be generated based upon the detected criteria. For instance, the criteria can be detected from a first asset added to the new information assemblage. Additionally or alternatively, the criteria can be detected from an identity of a creator of the new information assemblage. The criteria, for example, can be one or more of a target audience for the new information assemblage, a purpose of the new information assemblage, viewing preferences of the target audience of the new information assemblage, etc.

Pursuant to another example, the suggestion can indicate one or more of an asset to add to the new information assemblage, an asset to exclude from the new information assemblage, an order of assets in the new information assemblage, edits of an asset to be added to the new information assemblage, and so forth.

Moreover, distribution of the new information assemblage can be controlled. For example, the distribution of the new information assemblage can be controlled by setting at least one of a user that can view the new information assemblage or a given asset of the new information assemblage, a type of device that can be used to consume the new information assemblage or the given asset of the new information assemblage, whether the new information assemblage is permitted to be forwarded, a consumption order for the plurality of assets of the new information assemblage, requirements to progress from consumption of a first asset to a second asset included in the plurality of assets of the new information assemblage, or the like.

Further, a target audience to which the new information assemblage is distributed can be selected.

By way of another example, the new information assemblage can be shared between user devices (e.g., shared by a target device to a disparate user device that may or may not be included in the target audience). Thus, the new information assemblage is distributed to the target audience that includes a first user device (e.g., at 1106). Further, the new information assemblage can be distributed to a second user device upon receiving feedback that signifies that the new information assemblage was forwarded to the second user device from the first user device. Such sharing can be subject to various controls (e.g., providing who can access the new information assemblage or particular assets included in the new information assemblage, device(s) from which the new information assemblage can be opened/viewed, whether the new information can be shared, etc.). According to an illustration, the first user device can forward the new information assemblage to the second user device via near field communication; however, the claimed subject matter is not so limited.

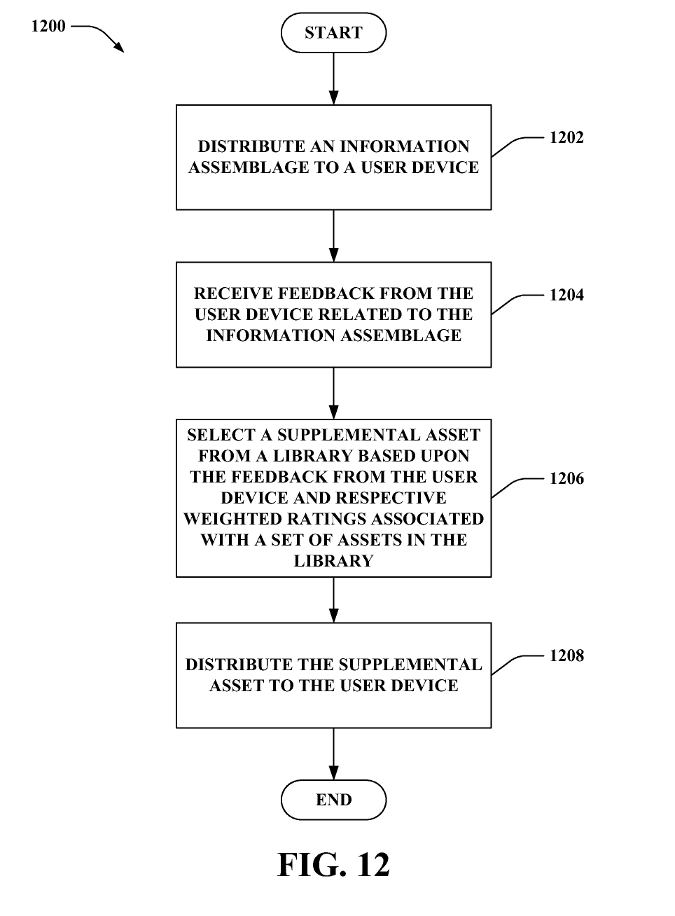

Turning to FIG. 12, illustrated is a methodology 1200 of supplying a supplemental asset. At 1202, an information assemblage can be distributed to a user device. The information assemblage, for instance, can include a plurality of assets of one or more asset types. Further, the one or more assets types can include one or more of video information, image information, audio information, documents, assessments, and so forth. At 1204, feedback can be received from the user device related to the information assemblage. At 1206, a supplemental asset from a library can be selected based upon the feedback from the user device and respective weighted ratings associated with a set of assets in the library. At 1208, the supplemental asset can be distributed to the user device.

By way of example, the supplemental asset can be selected (e.g., at 1206) and the supplemental asset can be distributed (e.g., at 1208) in response to the feedback indicating that the information assemblage was consumed by the user device. According to another example, the weighted ratings can be generated from at least one of global settings, individual settings, feedback corresponding to one or more of the information assemblage, previously distributed information assemblages, assets included in the information assemblage, or assets included in the previously distributed information assemblages, and so forth.

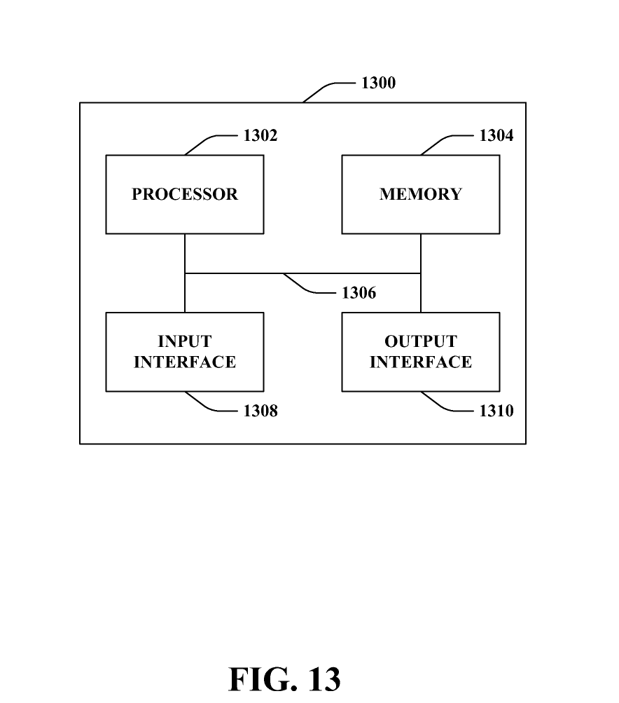

Referring now to FIG. 13, a high-level illustration of an example computing device 1300 that can be used in accordance with the systems and methodologies disclosed herein is illustrated. For instance, the computing device 1300 may be used in a system that creates and disseminates information assemblages to a target audience. In another example, at least a portion of the computer device 1300 can be used in a system that generates suggestions based on weighted ratings. The computing device 1300 includes at least one processor 1302 that executes instructions that are stored in a memory 1304 (e.g., the data store 122). The instructions may be, for instance, instructions for implementing functionality described as being carried out by one or more components discussed above or instructions for implementing one or more of the methods described above. The processor 1302 may access the memory 1304 by way of a system bus 1306. In addition to storing executable instructions, the memory 1304 may also store the library 114, feedback history 604, global settings 606, individual settings 608, and weighted ratings 610.

The computing device 1300 also includes an input interface 1308 that allows external devices to communicate with the computing device 1300. For instance, the input interface 1308 may be used to receive instructions from an external computer device, from a user, etc. The computing device 1300 also includes an output interface 1310 that interfaces the computing device 1300 with one or more external devices. For example, the computing device 1300 may display text, images, etc. by way of the output interface 1310.

Additionally, while illustrated as a single system, it is to be understood that the computing device 1300 may be a distributed system. Thus, for instance, several devices may be in communication by way of a network connection and may collectively perform tasks described as being performed by the computing device 1300.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Various functions described herein can be implemented in hardware, software, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of medium. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Combinations of the above should also be included within the scope of computer-readable media.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method of measuring compliance configured for execution on a processor of a message system, comprising:
maintaining an information assemblage that includes a plurality of assets in memory of the message system;
assigning respective weights to assets in a selected subset of the plurality of assets from the information assemblage;
disseminating the information assemblage;
monitoring feedback related to the information assemblage;
evaluating metrics for the assets in the selected subset from the feedback; and
generating a measure of compliance by combining results of the metrics for the assets in the selected subset as a function of the respective weights.

2. The method of claim 1, further comprising:
disseminating the information assemblage to a target audience that includes a plurality of recipients; and
generating respective measures of compliance corresponding to the plurality of recipients.

3. The method of claim 1, further comprising updating the measure of compliance in real time as the feedback related to the information assemblage is monitored.

4. The method of claim 1, wherein the plurality of assets comprise one or more asset types.

5. The method of claim 4, wherein the one or more asset types comprise one or more of video information, image information, audio information, documents, or assessments.

6. The method of claim 1, wherein evaluating a particular metric for a particular asset comprises at least one of:
detecting whether the particular asset in the information assemblage is opened based on the feedback;
detecting whether at least a predefined portion of the particular asset is viewed based on the feedback;
detecting whether a response to the particular asset is received in the feedback;
identifying a specific response to the particular asset that is received in the feedback;
detecting whether the information assemblage is shared based on the feedback;
detecting a type of device used to consume the particular asset or the information assemblage based on the feedback; or
recognizing a user rating for the particular asset received in the feedback.

7. The method of claim 1, wherein evaluating a particular metric for a video included in the information assemblage comprises at least one of:
detecting whether a given range of frames of the video are viewed based on the feedback; or
detecting whether a key frame of the video is viewed based on the feedback.

8. The method of claim 1, further comprising generating a suggestion for at least one of a given asset from the plurality of assets of the information assemblage to select or a weight to be assigned to the given asset.

9. The method of claim 8, further comprising generating the suggestion based on at least one of a global setting, an individual setting, previously disseminated information assemblages, or measures of compliance generated from the previously disseminated information assemblages.

10. The method of claim 1, further comprising generating a suggestion for at least one of an asset to add to the information assemblage, an asset to exclude from the information assemblage, an order of assets in the information assemblage, or potential edits of an asset to be added to the information assemblage.

11. The method of claim 1, further comprising receiving an input at the message system related to one or more assets to include in the selected subset of the plurality of assets from the information assemblage.

12. The method of claim 1, further comprising maintaining the information assemblage upon receiving the information assemblage at the message system.

13. The method of claim 1, further comprising maintaining the information assemblage upon the information assemblage being formed based at least in part upon an input received by the message system.

14. A method of forming a new information assemblage configured for execution on a processor of a message system, comprising:
initiating creation of the new information assemblage;
adding a plurality of assets to the new information assemblage in accordance with a suggestion generated based upon weighted ratings, wherein the plurality of assets of the new information assemblage comprises one or more asset types, the one or more asset types comprise one or more of video information, image information, audio information, documents, or assessments; and
distributing the new information assemblage.

15. The method of claim 14, further comprising generating the weighted ratings from one or more of feedback corresponding to previously distributed information assemblages, feedback corresponding to assets included in the previously distributed information assemblages, global settings, or individual settings.

16. The method of claim 15, wherein generating the weighted ratings further comprises:
evaluating metrics upon the feedback from respective target audiences for the previously distributed information assemblages and the assets included in the previously distributed information assemblages;
combining results of the metrics for the previously distributed information assemblages and the assets included in the previously distributed information assemblages according to respective weights to yield respective weighted ratings for the previously distributed information assemblages and the assets included in the previously distributed information assemblages; and
assigning the respective weighted ratings to characteristics of the previously distributed information assemblages and the assets included in the previously distributed information assemblages.

17. The method of claim 16, wherein evaluating a particular metric comprises at least one of:
detecting whether a particular asset in a particular information assemblage is opened based on the feedback;
detecting whether at least a predefined portion of the particular asset is viewed based on the feedback;
detecting whether a response to the particular asset is received in the feedback;
detecting a response rate for the particular asset or the particular information assemblage based on the feedback;
determining a percentage of the particular information assemblage that is consumed based on the feedback;
identifying a specific response to the particular asset that is received in the feedback;
detecting whether the particular information assemblage is shared based on the feedback;
detecting a type of device used to consume the particular asset or the particular information assemblage based on the feedback;
recognizing a user rating for the particular asset received in the feedback; or
identifying a rating or setting associated with a creator of the particular information assemblage or a global setting.

18. The method of claim 16, wherein evaluating a particular metric for a video included in a particular information assemblage comprises at least one of:
detecting whether a given range of frames of the video are viewed based on the feedback; or
detecting whether a key frame of the video is viewed based on the feedback.

19. The method of claim 16, wherein the characteristics comprise one or more of video length in a particular information assemblage, number of questions in an assessment included in the particular information assemblage, types of questions in the assessment included in the particular information assemblage, number of assets in the particular information assemblage, types of assets in the particular information assemblage, order of presentation of assets in the particular information assemblage, consumption order specified for assets in the particular information assemblage, or identity of assets in the particular information assemblage.

20. The method of claim 16, wherein the suggestion generated based upon weighted ratings for the new information assemblage specifies a subset of the characteristics to leverage in the new information assemblage.

21. The method of claim 16, further comprising updating the weighted ratings for the characteristics in real time as the previously distributed information assemblages and the assets included in the previously distributed information assemblages are consumed or completed by recipients in the respective target audiences.

22. The method of claim 14, further comprising:
detecting criteria for the new information assemblage; and
generating the suggestion for a subset of characteristics based upon the criteria.

23. The method of claim 22, further comprising detecting the criteria from a first asset added to the new information assemblage.

24. The method of claim 22, further comprising detecting the criteria from an identity of a creator of the new information assemblage.

25. The method of claim 22, wherein the criteria comprises at least one of a target audience for the new information assemblage, a purpose of the new information assemblage, or viewing preferences of the target audience of the new information assemblage.

26. The method of claim 14, wherein the suggestion indicates at least one of an asset to add to the new information assemblage, an asset to exclude from the new information assemblage, an order of assets in the new information assemblage, or edits of an asset to be added to the new information assemblage.

27. The method of claim 14, further comprising controlling distribution of the new information assemblage.

28. The method of claim 27, wherein the distribution of the new information assemblage is controlled by setting at least one of a user that can view the new information assemblage or a given asset of the new information assemblage, a type of device that can be used to consume the new information assemblage or the given asset of the new information assemblage, whether the new information assemblage is permitted to be forwarded, a consumption order for the plurality of assets of the new information assemblage, or requirements to progress from consumption of a first asset to a second asset included in the plurality of assets of the new information assemblage.

29. The method of claim 14, further comprising selecting a target audience to which the new information assemblage is distributed.

30. The method of claim 14, wherein the new information assemblage is distributed to a target audience that includes a first user device, further comprising:
distributing the new information assemblage to a second user device upon receiving feedback that signifies that the new information assemblage was forwarded to the second user device from the first user device.

31. The method of claim 30, wherein the first user device forwards the new information assemblage to the second user device via near field communication.

32. A method of supplying a supplemental asset configured for execution on a processor of a message system, comprising:
distributing an information assemblage to a user device, wherein the information assemblage comprises a plurality of assets of one or more asset types, the one or more asset types comprise one or more of video information, image information, audio information, documents, or assessments;
receiving feedback from the user device related to the information assemblage;
selecting the supplemental asset from a library based upon the feedback from the user device and respective weighted ratings associated with a set of assets in the library; and
distributing the supplemental asset to the user device.

33. The method of claim 32, further comprising selecting the supplemental asset and distributing the supplemental asset in response to the feedback indicating that the information assemblage was consumed by the user device.

34. The method of claim 32, further comprising generating the weighted ratings from at least one of global settings, individual settings, or feedback corresponding to one or more of the information assemblage, previously distributed information assemblages, assets included in the information assemblage, or assets included in the previously distributed information assemblages.

35. A system that distributes information assemblages, comprising:
memory that retains feedback history and a library that includes a set of assets;
a rating component that generates weighted ratings corresponding to characteristics of the assets in the set based at least in part upon the feedback history retained in the memory;
an assembly component that forms an information assemblage with a subset of assets from the set retained in the library based at least in part upon suggestions yielded from the weighted ratings corresponding to the characteristics of the assets in the set; and
a distribution component that disseminates the information assemblage to a target audience.

36. The system of claim 35, further comprising a monitor component that collects feedback from the target audience related to the information assemblage, wherein the feedback is included in the feedback history retained in the memory.

37. The system of claim 36, further comprising a compliance tracking component that evaluates metrics for one or more of the subset of assets included in the information assemblage from the feedback from the target audience and generates respective measures of compliance for recipients in the target audience by combining results of the metrics for the one or more of the subset of assets included in the information assemblage as a function of respective weights.

38. The system of claim 36, further comprising a supplement component that selects a supplemental asset to be disseminated to a user device by the distribution component based upon feedback received by the monitor component from the user device and the weighted ratings.
